(19) United States
(12) Patent Application Publication
(10) Pub. No.: US 2010/0209699 A1
(43) Pub. Date: Aug. 19, 2010

(54) ELECTROCONDUCTIVE PRESSURE-SENSITIVE ADHESIVE TAPE

(75) Inventors: Junichi Nakayama, Osaka (JP); Hiroaki Kishioka, Osaka (JP)

Correspondence Address: EDWARDS ANGELL PALMER & DODGE LLP, P.O. BOX 55874, BOSTON, MA, 02205, US

(73) Assignee: NITTO DENKO CORPORATION, Ibaraki-shi (JP)

(21) Appl. No.: 12/733,801

(22) PCT Filed: Sep. 19, 2008
(86) PCT No.: PCT/JP2008/067588

§ 371 Date: Mar. 19, 2010

(30) Foreign Application Priority Data
Sep. 26, 2007 (JP) 2007-249449

(51) Int. Cl. B32B 5/16; B32B 33/00

(52) U.S. Cl. 428/323; 428/343

(57) ABSTRACT

An electroconductive pressure-sensitive adhesive tape includes a pressure-sensitive adhesive layer containing a pressure-sensitive adhesive and having a thickness of 10 to 30 μm. The pressure-sensitive adhesive contains a spherical and/or spiking electroconductive filler in a content of 14 to 45 parts by weight per 100 parts by weight of the total solids contents of the pressure-sensitive adhesive other than fillers, the electroconductive filler has an aspect ratio of 1.0 to 1.5 and occupies 90 percent by weight or more of the total weight of fillers in the pressure-sensitive adhesive. The electroconductive filler has such particle diameters d₅₀ and d₈₅, and the pressure-sensitive adhesive layer has such a thickness as to satisfy the following condition: d₈₅>(the thickness of the pressure-sensitive adhesive layer)>d₅₀. Even when the pressure-sensitive adhesive layer is slimmed, the electroconductive pressure-sensitive adhesive tape excels in adhesiveness and electroconductivity and has such superior bump-absorptivity as not to suffer from “lifting” from an adherend even when applied to a bumped portion of the adherend. The tape is therefore useful typically for the production of electrical/electronic appliances.

### TECHNICAL FIELD

The present invention relates to electroconductive pressure-sensitive adhesive tapes.

### BACKGROUND ART

Electroconductive pressure-sensitive adhesive tapes (including electroconductive pressure-sensitive adhesive sheets) have been used for electromagnetic shielding from electrical/electronic appliances and cables and for establishing a ground for static protection. Examples of known electroconductive pressure-sensitive adhesive tapes include pressure-sensitive adhesive tapes each of which includes an electroconductive substrate such as a metallic foil; and a pressure-sensitive adhesive layer arranged on the electroconductive substrate, in which the pressure-sensitive adhesive layer includes an electroconductive pressure-sensitive adhesive containing a pressure-sensitive adhesive material and an electroconductive filler, such as a nickel powder, dispersed in the adhesive material (see Patent Documents 1 and 2).

Slimming of such electroconductive pressure-sensitive adhesive tapes for use in electrical/electronic appliances has been recently demanded, because the electrical/electronic appliances have become more and more small-sized and slimmed. Decreasing thicknesses of the pressure-sensitive adhesive layers, however, disturb the pressure-sensitive adhesive layers to have both satisfactory adhesiveness (tackiness) and sufficient electroconductivity; and raise new problems such that, when a tape having such a thin pressure-sensitive adhesive layer is applied to a portion with bumps, the thin pressure-sensitive adhesive layer can hardly absorb the bumps, and this causes “lifting” (insufficient adhesion) of the tape. Further improvements have therefore been demanded in these technologies.

Patent Document 1: Japanese Unexamined Patent Application Publication (JP-A) No. 2004-263030

Patent Document 2: Japanese Unexamined Patent Application Publication (JP-A) No. 2005-277145

### DISCLOSURE OF INVENTION

### Problems to be Solved by the Invention

Accordingly, an object of the present invention is to provide an electroconductive pressure-sensitive adhesive tape which excels in both adhesiveness and electroconductivity even when having a thin pressure-sensitive adhesive layer, and which satisfactorily absorbs bumps so as not to cause “lifting” from an adherend even when the tape is applied to a bumped portion of the adherend.

### Means for Solving the Problems

After intensive investigations to achieve the object, the present inventors have found that an electroconductive pressure-sensitive adhesive tape which excels in both adhesiveness and electroconductivity, and in bump-absorptivity even having a thin pressure-sensitive adhesive layer can be obtained in the following manner. Specifically, the electroconductive pressure-sensitive adhesive can be obtained from an electroconductive pressure-sensitive adhesive tape having a pressure-sensitive adhesive layer including an electroconductive pressure-sensitive adhesive containing a specific amount of an electroconductive filler in a specific form (shape) dispersed therein, by controlling the thickness of the pressure-sensitive adhesive layer and the particle diameters of the electroconductive filler (filler diameters) within a specific range. The present invention has been made based on these findings.

Specifically, the present invention provides, in an embodiment, an electroconductive pressure-sensitive adhesive tape which includes a pressure-sensitive adhesive layer including a pressure-sensitive adhesive and having a thickness of from 10 to 30 μm, in which the pressure-sensitive adhesive contains at least one electroconductive filler in a content of from 14 to 45 parts by weight per 100 parts by weight of the total solids content of the pressure-sensitive adhesive other than fillers, the at least one electroconductive filler is spherical and/or spiking, has an aspect ratio of 1.0 to 1.5, and occupies 90 percent by weight or more of the total weight of fillers contained in the pressure-sensitive adhesive, and in which the at least one electroconductive filler has such particle diameters d₅₀ and d₈₅, and the pressure-sensitive adhesive layer has such a thickness as to satisfy the following condition: d₈₅>(the thickness of the pressure-sensitive adhesive layer)>d₅₀.

In the electroconductive pressure-sensitive adhesive tape, the pressure-sensitive adhesive may be an acrylic pressure-sensitive adhesive.

The pressure-sensitive adhesive in the electroconductive pressure-sensitive adhesive tape, after crosslinked to have a crosslinked structure, may have a storage elastic modulus G′ of 1×10⁴ Pa or more and less than 1×10⁶ Pa at temperatures ranging from 0° C. to 40° C. as determined in a dynamic viscoelastic test and may have a peak temperature of loss tangent (dissipation factor) tan δ of 0° C. or lower.

The at least one electroconductive filler in the electroconductive pressure-sensitive adhesive tape may be at least one selected from the group consisting of metal fillers and metal-coated fillers.

The electroconductive pressure-sensitive adhesive tape may include a substrate containing a metallic foil; and the pressure-sensitive adhesive layer present on or above at least one surface of the substrate.

The pressure-sensitive adhesive layer in the electroconductive pressure-sensitive adhesive tape may be present on or above both surfaces of the substrate.

### ADVANTAGES

Electroconductive pressure-sensitive adhesive tapes according to embodiments of the present invention have the above configurations, thereby, though being thin, have both satisfactory adhesiveness and superior electroconductivity and do not suffer from “lifting” from adherends even when they are applied to bumped portions (uneven portions). When used in production typically of electrical/electronic appliances, the electroconductive pressure-sensitive adhesive tapes help to improve the productivity and quality of the resulting products.

### BRIEF DESCRIPTION OF DRAWINGS

FIG. 1 depicts an exemplary electron micrograph of spherical particles (4SP-400).

FIG. 2 depicts an exemplary electron micrograph of spiking particles (Ni123).

FIG. 3 depicts an exemplary electron micrograph of filamentary particles (Ni287).

FIG. 4 depicts an exemplary electron micrograph of flaky particles (Ni-Flake 95).

FIG. 5 is a schematic diagram showing how to evaluate resistances in Examples.

FIG. 6 is a schematic diagram showing how to evaluate bump-absorptivity in Examples.

### REFERENCE NUMERALS

1 soda-lime glass
2 aluminum foil
3 insulating tape
4 specimen
5 laminated portion (inside of the dotted box)
6 soda-lime glass
7 pressure-sensitive adhesive tape
8 specimen (electroconductive pressure-sensitive adhesive tape)
9 bumped portion

### BEST MODES FOR CARRYING OUT THE INVENTION

Electroconductive pressure-sensitive adhesive tapes according to embodiments of the present invention each have at least one pressure-sensitive adhesive layer containing an electroconductive filler. The electroconductive pressure-sensitive adhesive tapes may be either single-sided pressure-sensitive adhesive tapes having an adhesive face as only one surface thereof, or double-sided pressure-sensitive adhesive tapes having adhesive faces as both surfaces thereof. Independently, the electroconductive pressure-sensitive adhesive tapes may be either substrate-less (carrier-less) pressure-sensitive adhesive tapes including a pressure-sensitive adhesive layer alone (double-sided pressure-sensitive adhesive tapes) or substrate (electroconductive substrate)-supported pressure-sensitive adhesive tapes (single-sided pressure-sensitive adhesive tapes or double-sided pressure-sensitive adhesive tapes). Among them, substrate-supported electroconductive pressure-sensitive adhesive tapes are preferred from the viewpoints typically of handleability and workability. Typically, an exemplary preferred electroconductive pressure-sensitive adhesive tape is one having a multilayer structure including a metallic foil substrate (electroconductive substrate) and a pressure-sensitive adhesive layer (electroconductive pressure-sensitive adhesive layer) present on at least one side of the substrate. As used herein, the term “electroconductive pressure-sensitive adhesive tape” also includes one in a sheet form, namely, an “electroconductive pressure-sensitive adhesive sheet”.

The pressure-sensitive adhesive layers in the electroconductive pressure-sensitive adhesive tapes according to the present invention include pressure-sensitive adhesives (electroconductive pressure-sensitive adhesives). The pressure-sensitive adhesives each contain a base polymer and an electroconductive filler as essential components and further contain, according to necessity, any of tackifier resins, crosslinking agents, and other additives. Of such pressure-sensitive adhesives, acrylic pressure-sensitive adhesives including an acrylic polymer as a base polymer are preferred from the viewpoints of durability, weatherability (resistance to climate conditions), and thermal stability.

Examples of base polymers usable in the pressure-sensitive adhesive layers herein include base polymers for use in known pressure-sensitive adhesives, including rubber polymers such as natural rubbers and synthetic rubbers [for example, polyisoprene rubbers, styrene-butadiene (SB) rubbers, styrene-isoprene (SI) rubbers, styrene-isoprene-styrene block copolymer (SIS) rubbers, styrene-butadiene-styrene block copolymer (SBS) rubbers, styrene-ethylene-butylene-styrene block copolymer (SEBS) rubbers, styrene-ethylene-propylene-styrene block copolymer (SEPS) rubbers, styrene-ethylene-propylene block copolymer (SEP) rubbers, reclaimed rubbers, butyl rubbers, polyisobutylenes, and modified products of them]; acrylic polymers; silicone polymers; and vinyl ester polymers. Among them, acrylic polymers are preferably used.

The acrylic polymers are polymers including one or more alkyl(meth)acrylates and/or one or more alkoxyalkyl(meth)acrylates as principal monomer components. The acrylic polymers preferably further contain one or more carboxyl-containing monomers as copolymerizable monomer components, in addition to the principal monomer components. The acrylic polymers may further contain other monomer components according to necessity. As used herein the term “(meth)acrylic” means “acrylic” and/or “methacrylic”; and hereinafter the same.

The alkyl(meth)acrylates are not especially limited, as long as being alkyl(meth)acrylates whose alkyl moiety having 1 to 12 carbon atoms (preferably 4 to 12 carbon atoms). Exemplary alkyl(meth)acrylates include methyl(meth)acrylates, ethyl(meth)acrylates, n-propyl(meth)acrylates, isopropyl(meth)acrylates, n-butyl(meth)acrylates, isobutyl(meth)acrylates, sec-butyl(meth)acrylates, t-butyl(meth)acrylates, pentyl(meth)acrylates, isopentyl(meth)acrylates, neopentyl(meth)acrylates, hexyl(meth)acrylates, heptyl(meth)acrylates, octyl(meth)acrylates, isooctyl(meth)acrylates, 2-ethylhexyl(meth)acrylates, nonyl(meth)acrylates, isononyl(meth)acrylates, decyl(meth)acrylates, isodecyl(meth)acrylates, undecyl(meth)acrylates, and dodecyl(meth)acrylates. Among them, alkyl(meth)acrylates whose alkyl moiety having 4 to 12 carbon atoms are preferred, of which n-butyl acrylate (BA) and 2-ethylhexyl acrylate (2-EHA) are desirable, from the viewpoint of providing satisfactory viscoelastic properties.

Examples of the alkoxyalkyl (meth)acrylates include, but are not limited to, methoxyethyl(meth)acrylates and ethoxyethyl(meth)acrylates.

Each of different principal monomer components can be used alone or in combination.

In the acrylic polymers, the monomer proportion of alkyl(meth)acrylates and/or alkoxyalkyl(meth)acrylates as the principal monomer components is 50 percent by weight or more, preferably 80 percent by weight or more, and more preferably 90 percent by weight or more, of the weight of total monomer components. The monomer proportion of the principal monomer components is, in its upper limit, preferably 99 percent by weight or less, and more preferably 97 percent by weight or less. If the proportion of the principal monomer components is less than 50 percent by weight of the weight of total monomer components, the resulting pressure-sensitive adhesive may not exhibit suitable viscoelasticity. If the pressure-sensitive adhesive contains both one or more alkyl(meth)acrylates and one or more alkoxyalkyl(meth)acrylates, the total weight of the alkyl(meth)acrylates and alkoxyalkyl(meth)acrylates has only to fall within the above-specified range.

Examples of the carboxyl-containing monomers include (meth)acrylic acids, itaconic acid, maleic acid, fumaric acid, and crotonic acid. Exemplary carboxyl-containing monomers usable herein further include acid anhydrides of these carboxyl-containing monomers, including acid-anhydride-group-containing monomers such as maleic anhydride and itaconic anhydride. Each of these monomer components can be used alone or in combination.

The proportion of the carboxyl-containing monomers is preferably from 1 to 10 parts by weight, and more preferably from 3 to 8 parts by weight, per 100 parts by weight of total monomer components. If the proportion is less than 1 part by weight, the pressure-sensitive adhesive may not surely have satisfactory adhesiveness to adherends. In contrast, if it exceeds 10 parts by weight, the pressure-sensitive adhesive may have an excessively high viscosity and this may cause problems such as coating failure.

Examples of the other copolymerizable monomers include functional monomers including hydroxyl-containing monomers [e.g., hydroxyethyl(meth)acrylates, hydroxypropyl(meth)acrylates, and hydroxybutyl(meth)acrylates], epoxy-containing acrylic monomers [e.g., glycidyl(meth)acrylates and methylglycidyl(meth)acrylates], glycerol dimethacrylate, and 2-methacryloyloxyethyl isocyanate; multifunctional monomers such as triethylene glycol diacrylate, ethylene glycol dimethacrylate, and trimethylolpropane tri(meth)acrylates; nonaromatic-ring-containing (meth)acrylic esters including cycloalkyl(meth)acrylates (e.g., cyclohexyl(meth)acrylates) and isobornyl(meth)acrylates; aromatic-ring-containing (meth)acrylic esters including aryl(meth)acrylates [e.g., phenyl(meth)acrylates], aryloxyalkyl(meth)acrylates [e.g., phenoxyethyl(meth)acrylates], and arylalkyl(meth)acrylates [e.g., benzyl(meth)acrylates]; vinyl ester monomers such as vinyl acetate and vinyl propionate; styrenic monomers such as styrene and α-methylstyrene; olefinic monomers such as ethylene, propylene, isoprene, and butadiene; and vinyl ether monomers such as vinyl ethers. The proportions of such other copolymerizable monomers can be appropriately chosen according to the types of the respective monomer components, within a range of less than 10 parts by weight per 100 parts by weight of the total monomer components.

Of the acrylic polymers for use as the base polymer of the pressure-sensitive adhesive layer herein, typically preferred are acrylic polymers each including 20 to 50 percent by weight of 2-ethylhexyl acrylate, 40 to 79 percent by weight of n-butyl acrylate, and 1 to 10 percent by weight of acrylic acid, from the viewpoints typically of viscoelastic properties of the pressure-sensitive adhesive layers.

The acrylic polymers can be prepared according to known or common polymerization techniques. Exemplary polymerization techniques include solution polymerization, emulsion polymerization, bulk polymerization, and polymerization upon application of ultraviolet rays. Among them, solution polymerization is preferred in respects typically of dispersivity of the fillers and cost.

Polymerization initiators and chain-transfer agents for use in the polymerization of the acrylic polymers are not especially limited and can be suitably chosen from among known or common ones. More specifically, exemplary preferred polymerization initiators include oil-soluble polymerization initiators including azo polymerization initiators such as 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), 1,1″-azobis(cyclohexane-1-carbonitrile), 2,2′-azobis(2,4,4-trimethylpentane), and dimethyl 2,2′-azobis(2-methylpropionate); and peroxide polymerization initiators such as benzoyl peroxide, t-butyl hydroperoxide, di-t-butyl peroxide, t-butyl peroxybenzoate, dicumyl peroxide, 1,1-bis(t-butylperoxy)-3,3,5-trimethylcyclohexane, and 1,1-bis(t-butylperoxy)cyclododecane. Each of different polymerization initiators can be used alone or in combination. The amount of polymerization initiators may be a usual amount and can be chosen within ranges typically of approximately from 0.01 to 1 part by weight per 100 parts by weight of total monomer components.

Any of common solvents can be used in the solution polymerization. Exemplary solvents include organic solvents including esters such as ethyl acetate and n-butyl acetate; aromatic hydrocarbons such as toluene and benzene; aliphatic hydrocarbons such as n-hexane and n-heptane; alicyclic hydrocarbons such as cyclohexane and methylcyclohexane; and ketones such as methyl ethyl ketone and methyl isobutyl ketone. Each of different solvents can be used alone or in combination.

The weight-average molecular weights (Mw) of the acrylic polymers are preferably from 30×10⁴ to 100×10⁴, and more preferably from 40×10⁴ to 80×10⁴, from the viewpoints of coatability and bump-absorptivity. The weight-average molecular weights can be controlled by adjusting conditions and parameters such as the types and amounts of polymerization initiators and chain-transfer agents; the polymerization temperature, polymerization time (duration), monomer concentration, and rates of dropwise addition of monomers in polymerization. The weight-average molecular weights can be measured typically through gel permeation chromatography (GPC).

Electroconductive fillers (electroconductive particles) for use in the pressure-sensitive adhesive layers herein can be any of known or common ones. Exemplary electroconductive fillers include fillers made from metals such as nickel, iron, chromium, cobalt, aluminum, antimony, molybdenum, copper, silver, platinum, and gold, alloys or oxides of them, and carbons such as carbon black; and fillers including, for example, polymer beads or resins coated with them. Of these, metal fillers and/or metal-coated fillers are preferred, of which nickel powder is more preferred.

The electroconductive fillers herein are spherical and/or spiking in shape and are preferably spherical. Such spherical and/or spiking electroconductive fillers, when used, readily disperse uniformly and thereby help the pressure-sensitive adhesive to readily have both satisfactory adhesiveness and superior electroconductivity. A filamentary, flaky, and/or dendritic filler, if used, may not satisfactorily disperse and may form a coarse aggregate; or the filler particles may be arrayed in the pressure-sensitive adhesive layer in a horizontal direction in parallel with the adhesive face, and the pressure-sensitive adhesive layer may be unlikely to exhibit electroconductivity in a thickness direction; thus, the pressure-sensitive adhesive layer may not exhibit both satisfactory adhesiveness and superior electroconductivity; and, in addition, the electroconductive pressure-sensitive adhesive tape may have an inferior appearance. The aspect ratios of the electroconductive fillers are from 1.0 to 1.5, and preferably from 1.0 to 1.1. The aspect ratios can be measured typically with a scanning electron microscope (SEM).

The proportion of the electroconductive fillers in the total fillers contained in the pressure-sensitive adhesive is 90 percent by weight or more, preferably 95 percent by weight or more, and most preferably, the electroconductive fillers occupy substantially all of fillers (for example, 99 percent by weight or more) contained in the pressure-sensitive adhesive. If the proportion of the electroconductive fillers is less than 90 percent by weight, it means that large amounts of fillers of other form such as filamentary, flaky, and dendritic fillers are contained in the pressure-sensitive adhesive, and the pressure-sensitive adhesive does not show satisfactory adhesiveness and superior electroconductivity effectively.

The particle diameters of the electroconductive filler (also referred to as “filler diameters”) d₅₀ and d₈₅ should satisfy the following condition: dₙ>(the thickness of the pressure-sensitive adhesive layer)>d₅₀. The filler diameter d₈₅ is an 85% cumulative value in the particle diameter distribution (the particle diameter of a filler particle at 85% from the smallest particle diameter) and the filler diameter d₅₀ is a 50% cumulative value in the particle diameter distribution (median diameter). The filler diameters d₅₀ and d₈₅ are measured, for example, according to laser diffracted scatter analysis mentioned below. When the pressure-sensitive adhesive layer contains two or more different types of electroconductive fillers, the filler diameters are calculated based on the particle diameter distribution of a mixture of all the electroconductive fillers.

The pressure-sensitive adhesive layer can have both high electroconductivity and superior adhesiveness by controlling the filler diameters d₅₀ and dₙ to satisfy the above condition. If the filler diameter d₈₅ is equal to or less than the thickness of the pressure-sensitive adhesive layer, most of filler particles are embedded in the pressure-sensitive adhesive layer and do not satisfactorily help the pressure-sensitive adhesive layer to have sufficient electroconductivity in a thickness direction. In contrast, if the filler diameter d₅₀ is equal to or more than the thickness of the pressure-sensitive adhesive layer, a half or more of filler particles have sizes larger than the thickness of the pressure-sensitive adhesive layer to thereby form protrusions protruded from the surface of the pressure-sensitive adhesive layer, and this reduces the contact area between the pressure-sensitive adhesive layer and the adherend and thereby lowers adhesiveness between them. In addition, the electroconductive pressure-sensitive adhesive tape may have an inferior appearance. More specifically, though not critical, the filler diameter d₈₅ preferably ranges from 20 to 35 μm and the filler diameter d₅₀ preferably ranges from 5 to 20 μm.

Such electroconductive fillers are commercially available typically as “4SP-400” (spherical nickel particles) from Novamet Specialty Products Corporation; and “Ni123” (spiking nickel particles) from Vale Inco Limited.

The content of the electroconductive fillers in the pressure-sensitive adhesive layer is from 14 to 45 parts by weight per 100 parts by weight of the total solids content of the pressure-sensitive adhesive other than fillers. The electroconductive fillers, if contained in a content of more than 45 parts by weight, especially when the thickness of the pressure-sensitive adhesive layer is within the range herein, may aggregate with each other and/or may cause a roughened surface of the pressure-sensitive adhesive layer, and these may cause insufficient adhesiveness and inferior appearance of the electroconductive pressure-sensitive adhesive tape. In addition, such large amounts of electroconductive fillers are disadvantageous in cost. In contrast, electroconductive fillers, if contained in a content of less than 14 parts by weight, do not contribute to sufficient electroconductivity. As used herein the term “the total solids content of the pressure-sensitive adhesive other than fillers” refers to the solids content obtained by subtracting the solids content of total fillers contained in the pressure-sensitive adhesive from the total solids content of the pressure-sensitive adhesive.

The pressure-sensitive adhesive for use in the pressure-sensitive adhesive layers herein preferably further contains one or more tackifier resins (tackifiers) from the viewpoint of providing satisfactory adhesiveness. Exemplary tackifier resins include terpene tackifier resins, phenolic tackifier resins, rosin tackifier resins, and petroleum tackifier resins. Among them, rosin resins are preferred. Each of different tackifiers can be used alone or in combination.

Examples of the terpene tackifier resins include terpene resins such as α-pinene polymers, β-pinene polymers, and dipentene polymers; and modified terpene resins such as terpene-phenol resins, styrene-modified terpene resins, aromatic-modified terpene resins, and hydrogenated terpene resins, which modified terpene resins are derived from such terpene resins through modification (e.g., phenol modification, aromatic modification, hydrogenation modification, or hydrocarbon modification).

Exemplary phenol tackifier resins include condensates of formaldehyde and any of phenols (e.g., phenol, m-cresol, 3,5-xylenol, p-alkylphenol, and resorcinol), such as alkyl-phenol resins and xylene-formaldehyde resins; resols prepared by an addition reaction of any of the phenols with formaldehyde by the catalysis of an alkali (base) catalyst; novolacs prepared by a condensation reaction of any of the phenols with formaldehyde by the catalysis of an acid catalyst; and rosin-modified phenol resins prepared by adding phenol to any of rosins (e.g., unmodified rosins, modified rosins, and rosin derivatives) by the catalysis of an acid catalyst and carrying out thermal polymerization.

Exemplary rosin tackifier resins include unmodified rosins (crude rosins) such as gum rosin, wood rosin, and tall oil rosin; modified rosins prepared from these unmodified rosins by modification typically through hydrogenation, disproportionation, or polymerization, such as hydrogenated rosins, disproportionated rosins, polymerized rosins, and other chemically modified rosins; and a variety of rosin derivatives. The rosin derivatives include, for example, rosin esters such as rosin ester compounds obtained from unmodified rosins through esterification with alcohols, and modified rosin ester compounds obtained from modified rosins (e.g., hydrogenated rosins, disproportionated rosins, and polymerized rosins) through esterification with alcohols; unsaturated-fatty-acid-modified rosins obtained from unmodified rosins or modified rosins (e.g., hydrogenated rosins, disproportionated rosins, and polymerized rosins) through modification with unsaturated fatty acids; unsaturated-fatty-acid-modified rosin esters obtained from rosin esters through modification with unsaturated fatty acids; rosin alcohols obtained from unmodified rosins, modified rosins (e.g., hydrogenated rosins, disproportionated rosins, and polymerized rosins), unsaturated-fatty-acid-modified rosins, or unsaturated-fatty-acid-modified rosin esters through reduction of carboxyl groups therein; and metal salts of rosins such as unmodified rosins, modified rosins, and rosin derivatives, of which metal salts of rosin esters are preferred.

The petroleum tackifier resins can be known petroleum resins such as aromatic petroleum resins, aliphatic petroleum resins, alicyclic petroleum resins (aliphatic cyclic petroleum resins), aliphatic/aromatic petroleum resins, aliphatic/alicyclic petroleum resins, hydrogenated petroleum resins, coumarone resins, and coumarone-indene resins. Specifically, exemplary aromatic petroleum resins include polymers each using one or more vinyl-containing aromatic hydrocarbons having 8 to 10 carbon atoms, such as styrene, o-vinyltoluene, m-vinyltoluene, p-vinyltoluene, α-methylstyrene, β-methylstyrene, indene, and methylindene. Of such aromatic petroleum resins, preferred are aromatic petroleum resins (so-called “C9 petroleum resins”) derived from a fraction including vinyltoluene and indene (so-called “C9 petroleum fraction”). Exemplary aliphatic petroleum resins include polymers each using one or more of olefins and dienes having 4 or 5 carbon atoms, including olefins such as butene-1, isobutylene, and pentene-1; and dienes such as butadiene, piperylene (1,3-pentadiene), and isoprene. Of such aliphatic petroleum resins, preferred are aliphatic petroleum resins (e.g., so-called “C4 petroleum resins” and “C5 petroleum resins”) obtained from fractions including butadiene, piperylene, and isoprene (e.g., so-called “C4 petroleum fraction” and “C5 petroleum fraction”). Exemplary alicyclic petroleum resins include alicyclic hydrocarbon resins prepared by cyclizing and dimerizing aliphatic petroleum resins (e.g., so-called “C4 petroleum resins” and “C5 petroleum resins”) and polymerizing the cyclized and dimerized products; polymers and hydrogenated products thereof, of cyclic diene compounds such as cyclopentadiene, dicyclopentadiene, ethylidenenorbornene, dipentene, ethylidenebicycloheptene, vinylcycloheptene, tetrahydroindene, vinylcyclohexene, and limonene; and alicyclic hydrocarbon resins obtained from the aromatic hydrocarbons resins or aliphatic/aromatic petroleum resins mentioned below through hydrogenation of their aromatic rings. Exemplary aliphatic/aromatic petroleum resins include styrene-olefin copolymers. Exemplary aliphatic/aromatic petroleum resins include so-called “C5/C9 copolymerized petroleum resins”.

The tackifier resins are also available as commercial products, such as trade name “HARIESTER” from Harima Chemicals, Inc.; trade names “ESTER GUM” and “PENSEL” from Arakawa Chemical Industries, Ltd.; and trade name “Rikatac” from Rika Fine-Tech Inc.

Though not limited, the content of tackifier resins in the pressure-sensitive adhesive is preferably from 10 to 50 parts by weight, and more preferably from 15 to 45 parts by weight, per 100 parts by weight of the total solids content of the base polymer (e.g. an acrylic polymer) from the viewpoint of providing satisfactory adhesiveness.

The pressure-sensitive adhesive for use in the pressure-sensitive adhesive layer herein preferably further contains one or more crosslinking agents from the viewpoint of controlling the gel fraction (the proportion of solvent insoluble matter) of the pressure-sensitive adhesive layer. Exemplary crosslinking agents include isocyanate crosslinking agents, epoxy crosslinking agents, melamine crosslinking agents, peroxide crosslinking agents, urea crosslinking agents, metal alkoxide crosslinking agents, metal chelate crosslinking agents, metal salt crosslinking agents, carbodiimide crosslinking agents, oxazoline crosslinking agents, aziridine crosslinking agents, and amine crosslinking agents. Among them, isocyanate crosslinking agents and epoxy crosslinking agents are preferred. Each of different crosslinking agents can be used alone or in combination.

Exemplary isocyanate crosslinking agents include lower aliphatic polyisocyanates such as 1,2-ethylene diisocyanate, 1,4-butylene diisocyanate, and 1,6-hexamethylene diisocyanate; alicyclic polyisocyanates such as cyclopentylene diisocyanate, cyclohexylene diisocyanate, isophorone diisocyanate, hydrogenated tolylene diisocyanate, and hydrogenated xylene diisocyanate; aromatic polyisocyanates such as 2,4-tolylene diisocyanate, 2,6-tolylene diisocyanate, 4,4″-diphenylmethane diisocyanate, and xylylene diisocyanate. Exemplary isocyanate crosslinking agents usable herein further include an adduct of trimethylolpropane with tolylene diisocyanate [trade name “CORONATE L” supplied by Nippon Polyurethane Industry Co., Ltd.] and an adduct of trimethylolpropane with hexamethylene diisocyanate [trade name “CORONATE HL” supplied by Nippon Polyurethane Industry Co., Ltd.].

Exemplary epoxy crosslinking agents include N,N,N′,N′-tetraglycidyl-m-xylenediamine, diglycidylaniline, 1,3-bis(N,N-glycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ethers, polypropylene glycol diglycidyl ethers, sorbitol polyglycidyl ethers, glycerol polyglycidyl ethers, pentaerythritol polyglycidyl ethers, polyglycerol polyglycidyl ethers, sorbitan polyglycidyl ethers, trimethylolpropane polyglycidyl ethers, diglycidyl adipate, diglycidyl o-phthalate, triglycidyl-tris(2-hydroxyethyl)isocyanurate, resorcinol diglycidyl ether, bisphenol-S-diglycidyl ether, and epoxy resins each having two or more epoxy groups per molecule.

Though not critical, the content of crosslinking agents in the pressure-sensitive adhesive is preferably from 0.001 to 10 parts by weight per 100 parts by weight of the total solids content of the base polymer (e.g. an acrylic polymer), from the viewpoint of bump-absorptivity.

Where necessary, the pressure-sensitive adhesive for use in the pressure-sensitive adhesive layers herein may further contain, in addition to the above components, any of known additives within ranges not adversely affecting the advantages of the present invention. Exemplary additives include age inhibitors, fillers, colorants (e.g., pigments and dyestuffs), ultraviolet-absorbers, antioxidants, plasticizers, softeners, and surfactants.

The pressure-sensitive adhesive may be formed into a solution (pressure-sensitive adhesive solution) before use by suitably controlling its viscosity with one or more common solvents. Examples of such solvents include organic solvents including esters such as ethyl acetate and n-butyl acetate; aromatic hydrocarbons such as toluene and benzene; aliphatic hydrocarbons such as n-hexane and n-heptane; alicyclic hydrocarbons such as cyclohexane and methylcyclohexane; and ketones such as methyl ethyl ketone and methyl isobutyl ketone. Each of different solvents can be used alone or in combination.

The pressure-sensitive adhesive for use in the pressure-sensitive adhesive layers, after crosslinked to have a crosslinked structure (namely, in the form of a pressure-sensitive adhesive layer), preferably has a storage elastic modulus G′ of 1×10⁴ Pa or more and less than 1×10⁶ Pa at temperatures ranging from 0° C. to 40° C. as determined in a dynamic viscoelastic test. A pressure-sensitive adhesive, after crosslinked to have a crosslinked structure, if having a storage elastic modulus G′ of less than 1×10⁴ Pa, may give an excessively soft or flexible pressure-sensitive adhesive layer to thereby have inferior cohesive strength. In contrast, a pressure-sensitive adhesive, after crosslinked to have a crosslinked structure, if having a storage elastic modulus G′ of 1×10⁶ Pa or more, may give an excessively hard pressure-sensitive adhesive layer to have inferior bump-absorptivity, and the resulting pressure-sensitive adhesive tape, when applied to a bumped portion, may often suffer from “lifting”. The pressure-sensitive adhesive, after crosslinked to have a crosslinked structure, preferably has a peak temperature of loss tangent tan δ of 0° C. or lower, and more preferably −10° C. or lower. A pressure-sensitive adhesive, after crosslinked to have a crosslinked structure, if having a peak temperature of tan δ of higher than 0° C., may cause the pressure-sensitive adhesive layer to be excessively hard at low temperatures, and this may remarkably impede affixing working or may lower bump-absorptivity.

The properties of the pressure-sensitive adhesive, after allowed to have a crosslinked structure, can be controlled by modifying conditions and parameters such as the monomer composition and molecular weight of the base polymer of the pressure-sensitive adhesive, and the types and contents of tackifiers.

The way to form pressure-sensitive adhesive layers of the electroconductive pressure-sensitive adhesive tapes is not particularly limited and may be suitably selected from among known techniques for forming pressure-sensitive adhesive layers. Specifically but merely by way of example, exemplary techniques include a direct application technique in which the pressure-sensitive adhesive (or a solution thereof in a solvent such as an organic solvent) is applied to a predetermined surface (e.g., a surface of the substrate) to give a layer having a predetermined thickness after drying, and the applied film is dried or cured according to necessity to form a pressure-sensitive adhesive layer; and a transfer technique in which the pressure-sensitive adhesive (or a solution thereof) is applied to a suitable release liner to give a layer having a predetermined thickness after drying, the applied film is dried or cured according to necessity to form a pressure-sensitive adhesive layer, and the formed pressure-sensitive adhesive layer is transferred onto a predetermined surface (e.g., a surface of the substrate). The application or coating of the pressure-sensitive adhesive (or a solution thereof) may be conducted using a common coater. Exemplary coaters include gravure roll coaters, reverse roll coaters, kiss-roll coaters, dip roll coaters, bar coaters, knife coaters, and spray coaters.

The thickness of the pressure-sensitive adhesive layer in the electroconductive pressure-sensitive adhesive tapes herein is from 10 to 30 μm, and preferably from 15 to 25 μm. A pressure-sensitive adhesive layer, if having a thickness of more than 30 μm, may be disadvantageous from the viewpoints of reduction in weight and thickness of electrical/electronic appliances and/or may cause increased cost, thus being undesirable. A pressure-sensitive adhesive layer, if having a thickness of less than 10 μm, may disturb the electroconductive pressure-sensitive adhesive tape to have both high electroconductivity and satisfactory adhesiveness.

In an embodiment of the present invention, the electroconductive pressure-sensitive adhesive tape is a substrate-supported electroconductive pressure-sensitive adhesive tape. In this case, the substrate (electroconductive substrate) preferably includes a metallic foil. The material for the metallic foil is not especially limited, as long as having electroconductivity, and examples thereof include metals such as copper, aluminum, nickel, silver, and iron, and alloys of these metals. Of such metallic foils, aluminum foil and copper foil are preferred from the viewpoints of cost and workability.

The thickness of the metallic foil is preferably from 10 to 100 μm, and more preferably from 30 to 70 μm from the viewpoint typically of reduction in weight and thickness, cost, and bump-absorptivity.

The electroconductive pressure-sensitive adhesive tape according to an embodiment of the present invention, when being a substrate-supported electroconductive pressure-sensitive adhesive tape, preferably has a multilayer structure including an electroconductive substrate composed of the metallic foil; and the electroconductive pressure-sensitive adhesive layer present on or above at least one surface of the electroconductive substrate. The electroconductive pressure-sensitive adhesive tape may be either a single-sided pressure-sensitive adhesive tape including the pressure-sensitive adhesive layer present on or above only one side of the substrate, or a double-sided pressure-sensitive adhesive tape including the pressure-sensitive adhesive layer present on or above both surfaces of the substrate. In the electroconductive pressure-sensitive adhesive tapes according to embodiments of the present invention, it is preferred that all the layers have electroconductivity.

The thicknesses of the electroconductive pressure-sensitive adhesive tapes are preferably from 15 to 160 μm, and more preferably from 15 to 120 μm, from the viewpoints of reduction in thickness and weight of electrical/electronic appliances as adherends.

The adhesive strengths (to a SUS (stainless steel) sheet, 180-degree peel) of the electroconductive pressure-sensitive adhesive layers of the electroconductive pressure-sensitive adhesive tapes are preferably from 3 to 15 newtons per 20 mm (N/20 mm).

The surfaces (adhesive faces) of the pressure-sensitive adhesive layers of the electroconductive pressure-sensitive adhesive tapes are preferably protected with release liners (separators) until usage of the tapes, from the viewpoints of surface protection and inhibition of blocking of the pressure-sensitive adhesive layers. The separators for use herein are not especially limited and can be any of known or common release papers and other separators. Exemplary separators usable herein include base materials having a releasable layer, such as plastic films and papers whose surfaces have been treated with a release agent such as a silicone release agent, a long-chain alkyl release agent, a fluorine-containing release agent, or molybdenum sulfide; low-adhesive base materials made from fluorine-containing polymers such as polytetrafluoroethylenes, polychlorotrifluoroethylenes, poly(vinyl fluoride)s, poly(vinylidene fluoride)s, tetrafluoroethylene-hexafluoropropylene copolymers, and chlorofluoroethylene-vinylidene fluoride copolymers; and low-adhesive base materials made from nonpolar polymers such as olefinic resins (e.g., polyethylenes and polypropylenes).

The electroconductive pressure-sensitive adhesive tapes according to embodiments of the present invention have satisfactory adhesive strength (bond strength) and high electroconductivity and are thereby advantageously usable for electromagnetic shielding typically from electrical/electronic appliances and cables and for establishing a ground for static protection typically of electrical components and optical films.

### [Methods for Measurements of Properties and Evaluations of Advantageous Effects]

Exemplary methods for use herein for the measurements of properties and for the evaluations of advantageous effects will be illustrated below.

(1) Filler Diameters d₅₀ and d₈₅

The filler diameters d₅₀ and d₈₅ were measured using the Laser Diffracted Scatter Microtrac Particle Size Analyzer MT3300 (supplied by Nikkiso Co., Ltd.).

The measurements were performed by using water (refractive index of 1.33) as a solvent; adding a specimen (filler) to the solvent in such a concentration of the specimen as to give a dv of from 0.02 to 0.5; applying ultrasonic waves thereto for 3 minutes using an ultrasonic device (output 40 W); and carrying out measurement (measurement condition: particle permeability: reflective) while circulating the specimen in water at a flow rate of 70% (35 cc per minute). The “dv” is a nondimensional value obtained from the diffraction volume (diffracted light volume) from the particles to be measured, is a value in proportion to the volume of particles in the measurement unit, and is an index adopted in Microtrac to decide the concentration of specimen upon measurement.

(2) Thickness of Pressure-Sensitive Adhesive Layer (in accordance with JIS Z 0237)

The thickness of a pressure-sensitive adhesive layer was measured using a dial gauge specified in Japanese Industrial Standards (JIS) B 7503. The dial gauge used herein had a flat contact face and had a diameter of 5 mm.

The thicknesses of a test piece 150 mm wide were measured at five points evenly spaced in a width direction with a dial gauge graduated in 1/1000 mm.

### (3) Aspect Ratio of Electroconductive Filler

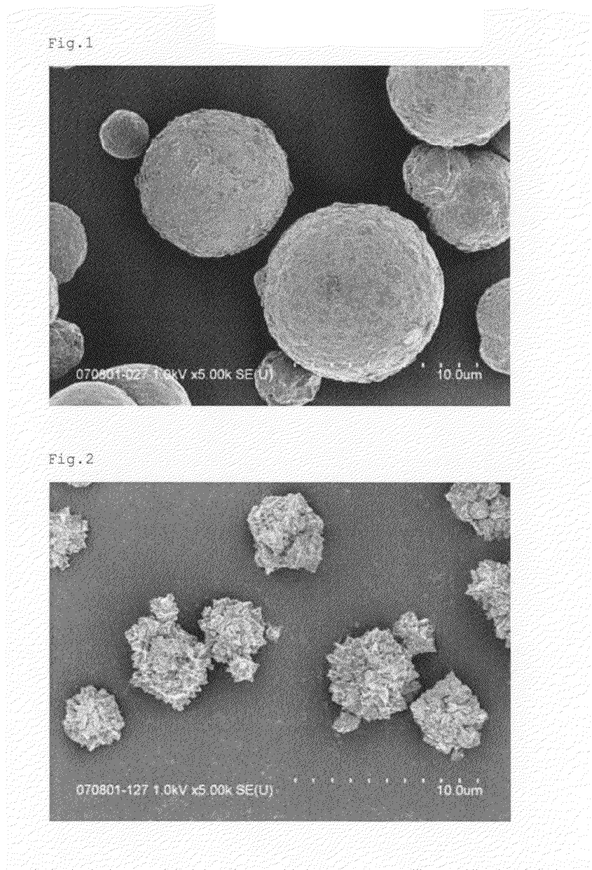

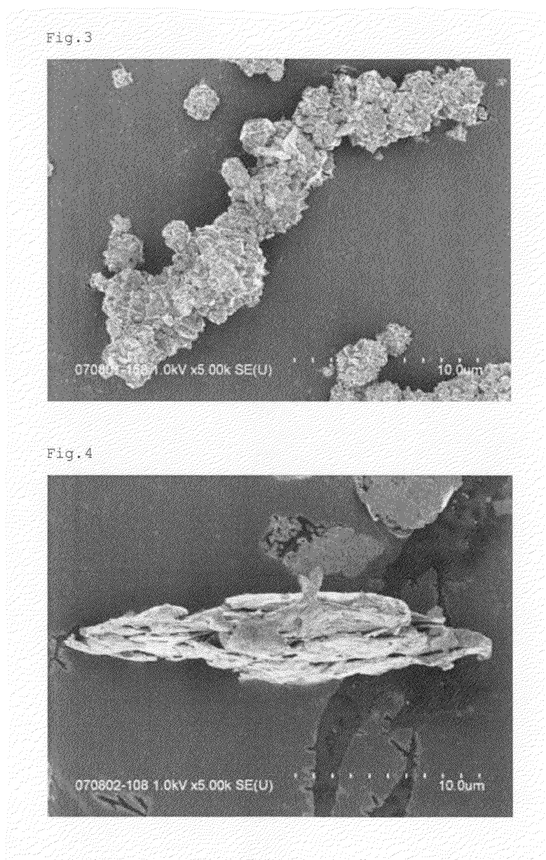

The aspect ratio of an electroconductive filler was measured with a scanning electron microscope (field emission scanning electron microscope; FE-SEM) (“S-4800” supplied by Hitachi High-Technologies Corporation). Specifically, the specimen (filler) was directly fixed to a specimen support (stage) and subjected to Pt—Pd sputtering for 25 seconds, and a secondary electron image of the resulting specimen was observed at an acceleration voltage of 1 kV. Exemplary electron micrographs (secondary electron images) of spherical particles, spiking particles, filamentary particles, and flaky particles are shown in FIGS. 1 to 4, respectively.

Based on the resulting electron images, the lengths of minor axis and major axis were respectively measured on arbitrary ten filler particles (not aggregated), and the ratio of the length of the major axis to that of the minor axis was defined as an aspect ratio. The measured ten aspect ratios per one specimen were averaged, and this was defined as the aspect ratio of the specimen. For the flaky (cylindrical) filler, the ratio of the diameter to the thickness was defined as the aspect ratio.

The measurements are desirably carried out by using a powdery filler (before being added to the pressure-sensitive adhesive), but can be carried out by using a filler extracted from the pressure-sensitive adhesive layer.

### (4) Measurements of Dynamic Viscoelasticity G′ and Peak Temperature of tan δ

Each of pressure-sensitive adhesives (pressure-sensitive adhesive solutions) prepared in examples and comparative examples below was applied to a separator to form a layer of pressure-sensitive adhesive; the layer of pressure-sensitive adhesive was heated and dried to have a crosslinked structure; and two or more plies of the layer of crosslinked pressure-sensitive adhesive were stacked to a thickness of about 1.5 mm. This (crosslinked pressure-sensitive adhesive having a thickness of about 1.5 mm) was punched to a diameter of 7.9 mm to give a test portion.

Dynamic viscoelasticity measurements were performed on the test portion using the dynamic viscoelasticity measurement system “ARES” supplied by Rheometric Scientific Inc., and a storage elastic modulus G′ and a peak temperature of loss tangent tan δ were determined.

Device: ARES (Advanced Rheometric Expansion System) supplied by Rheometric Scientific Inc.

Frequency: 1 Hz

Temperatures: −70° C. to 200° C.

Rate of temperature rise: 5° C. per minute

### (5) Adhesive Strength

Each of the electroconductive pressure-sensitive adhesive tape samples (samples each 20 mm wide) prepared in the examples and comparative examples was affixed to a stainless steel sheet (SUS 304 steel sheet) in an atmosphere of a temperature of 23° C. and relative humidity of 60% through one reciprocating movement of a roller having a weight of 2.0 kg and a width of 30 mm. The affixed portion had a length of 100 mm. The resulting article was left stand at ordinary temperature (23° C. and relative humidity of 60%) for 30 minutes, subjected to a 180-degree peel test using a tensile tester at a tensile speed of 300 mm per minute in accordance with the method specified in JIS Z 0237, and a peel adhesive strength (newton per 20 mm; N/20 mm) was measured.

### (6) Resistance

A specimen 15 mm wide and 20 mm long was cut from each of the electroconductive pressure-sensitive adhesive tapes prepared in the examples and comparative examples.

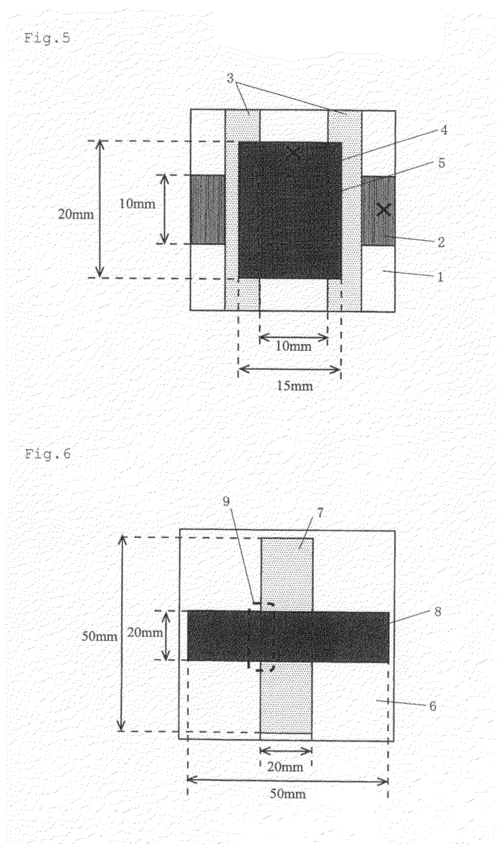

To give dimensions shown in FIG. 5, an insulating tape 3 was laid on an aluminum foil 2, and the aluminum foil 2 and the specimen 4 were affixed with each other through compression bonding with a hand roller (30 mm wide) at a pressure of 5.0 N/cm in an atmosphere of ordinary temperature, to give an area of a laminated portion 5 (inside of the dotted box) of 1.00 cm². The affixation was performed so that the vertical direction in FIG. 5 be the longitudinal direction of the specimen 4; and the surface of electroconductive pressure-sensitive adhesive layer of the pressure-sensitive adhesive tape specimen be in contact with the surface of the aluminum foil.

After being affixed with each other, the aluminum foil and the specimen were left stand in an atmosphere of ordinary temperature for 15 minutes, two terminals were connected to one end portion (portion not affixed) of the specimen and to an end portion of the aluminum foil, each portion is crossed in FIG. 5, and the resistance between the terminals was measured in units of milliohm per square centimeter (mΩ/cm²) with a milliohm (mΩ) meter (trade name “mΩ HiTester” supplied by HIOKI E.E. CORPORATION).

### (7) Bump-Absorptivity

A pressure-sensitive adhesive tape 7 (“No. 31B” supplied by Nitto Denko Corporation; single-sided pressure-sensitive adhesive tape having a PET film substrate) 50 mm long, 20 mm wide, and 75 μm thick was affixed to a glass plate (soda-lime glass) 6 to form bumps 75 μm high (FIG. 6).

An electroconductive pressure-sensitive adhesive tape 8. (50 mm long and 20 mm wide) as a specimen was affixed over the bumps using a hand roller (30 mm wide). The resulting article was left stand in an atmosphere of a temperature of 23° C. and relative humidity of 60% for 24 hours, and a split distance (distance between the edge of bump and the contact point of the tape) in a bumped portion 9 was measured.

A specimen having a split distance of 2.0 mm or less was evaluated as having good bump-absorptivity (Good), and one having a split distance of more than 2.0 mm was evaluated as having poor bump-absorptivity (Poor).

### EXAMPLES

The present invention will be illustrated in further detail with reference to several examples below. It should be noted, however, that these examples are never construed to limit the scope of the present invention. Details of electroconductive fillers used in the examples and comparative examples, and structures, evaluation results, and other data of the resulting electroconductive pressure-sensitive adhesive tapes are shown in Tables 1 and 2.

### Example 1

Solution polymerization (65° C. for 5 hours, 80° C. for 2 hours) of 30 parts by weight of 2-ethylhexyl acrylate, 67 parts by weight of n-butyl acrylate, and 3 parts by weight of acrylic acid was conducted according to a common procedure using toluene as a solvent and 0.1 part by weight of azobisisobutyronitrile as an initiator and thereby yielded a solution (having a solids concentration of 40.0 percent by weight) of an acrylic polymer having a weight-average molecular weight of about 50×10⁴.

To 100 parts by weight of the solid contents of the acrylic polymer solution was added 35 parts by weight of a polymerized rosins pentaerythritol ester (“PENSEL D-125” supplied by Arakawa Chemical Industries, Ltd.) as a tackifier resin and thereby yielded a solution of acrylic resin composition having a solids content of 46.8 percent by weight.

To 100 parts by weight of the solids contents of the solution of acrylic resin composition were added 35 parts by weight of a nickel powder (“4SP-400” supplied by Novamet Specialty Products Corporation, filler diameters d₅₀ of 12.0 μm and d₈₅ of 26.2 μm, spherical), 100 parts by weight of toluene, and 2 parts by weight (in terms of solids content) of an isocyanate crosslinking agent (trade name “CORONATE L” supplied by Nippon Polyurethane Industry Co., Ltd.), the resulting mixture was stirred with a stirrer for 10 minutes, and thereby yielded a solution of electroconductive pressure-sensitive adhesive (acrylic pressure-sensitive adhesive solution).

The electroconductive pressure-sensitive adhesive had a storage elastic modulus (G′) of 5.3×10⁵ Pa at 0° C. and of 7.4×10⁴ Pa at 40° C. and had a peak temperature of loss tangent (tan δ) of −12° C. In this connection, electroconductive pressure-sensitive adhesives prepared according to Examples 2 to 8 and Comparative Examples 1 to 6 had the same storage elastic modulus (G′) and peak temperature of tan δ as those of the electroconductive pressure-sensitive adhesive prepared in Example 1.

The prepared electroconductive pressure-sensitive adhesive solution was applied to a release paper 163 μm thick (“110EPS(P) Blue” supplied by Oji Paper Co., Ltd.) so as to give a pressure-sensitive adhesive layer 20 μm thick, was dried in a dryer at 120° C. for 3 minutes, affixed to an aluminum foil (Al foil) 40 μm thick (trade name “BESPA” supplied by SUMIKEI ALUMINUM FOIL Co., Ltd.), aged at 50° C. for 2 days, and thereby yielded an electroconductive pressure-sensitive adhesive tape.

### Examples 2 and 3

A series of electroconductive pressure-sensitive adhesive tapes was prepared by the procedure of Example 1, except for modifying the content of the electroconductive filler as given in Table 1.

### Examples 4 and 5

A series of electroconductive pressure-sensitive adhesive tapes was prepared by the procedure of Example 1, except for modifying the thickness of the pressure-sensitive adhesive layer as given in Table 1.

### Example 6 and 7

A series of electroconductive pressure-sensitive adhesive tapes was prepared by the procedure of Example 1, except for using another nickel powder “Ni123” (filler diameters d₅₀ of 11.2 μm and d₈₅ of 26.2 μm, spiking) supplied by Vale Inco Limited instead of “4SP-400”, and further except for, in Example 6, modifying the thickness of the pressure-sensitive adhesive layer as given in Table 1.

### Example 8

An electroconductive pressure-sensitive adhesive tape was prepared by the procedure of Example 1, except for not using a substrate, as shown in Table 1. However, evaluations were performed after affixing the tape to an aluminum foil 40 μm thick.

### Comparative Example 1

An electroconductive pressure-sensitive adhesive tape was prepared by the procedure of Example 1, except for modifying the content of the electroconductive filler as given in Table 2.

### Comparative Example 2

An electroconductive pressure-sensitive adhesive tape was prepared by the procedure of Example 1, except for forming the pressure-sensitive adhesive layer to have a thickness equal to or less than the filler diameter d₅₀, as shown in Table 2.

### Comparative Example 3

An electroconductive pressure-sensitive adhesive tape was prepared by the procedure of Example 1, except for forming the pressure-sensitive adhesive layer to have a thickness equal to or more than the filler diameter d₈₅, as shown in Table 2.

### Comparative Examples 4 and 5

A series of electroconductive pressure-sensitive adhesive tapes was prepared by the procedure of Example 1, except for using, as nickel powders, “Ni287” (filler diameters d₅₀ of 21.5 μm and d₈₅ of 48.0 μm, filamentary) supplied by Vale Inco Limited and “Ni123” supplied by Vale Inco Limited instead of “4SP-400” and modifying the conditions such as the content of electroconductive filler and the thickness of the pressure-sensitive adhesive layer as given in Table 2.

### Comparative Example 6

An electroconductive pressure-sensitive adhesive tape was prepared by the procedure of Example 1, except for using another nickel powder “Ni-Flake 95” (filler diameters d₅₀ of 10.7 μm and d₈₅ of 22.9 μm, flaky) supplied by Fukuda Metal Foil and Powder Co., Ltd.“, as shown in Table 2.

TABLE 1

| | | Example 1 | Example 2 | Example 3 | Example 4 | Example 5 | Example 6 | Example 7 | Example 8 |
|---|---|---|---|---|---|---|---|---|---|
| Electroconductive filler | Filler type | nickel | nickel | nickel | nickel | nickel | nickel | nickel | nickel |
| | Name | 4SP-400 | 4SP-400 | 4SP-400 | 4SP-400 | 4SP-400 | Ni123 | Ni123 | 4SP-400 |
| | d₅₀ (μm) | 12.0 | 12.0 | 12.0 | 12.0 | 12.0 | 11.2 | 11.2 | 12.0 |
| | d₈₅ (μm) | 26.2 | 26.2 | 26.2 | 26.2 | 26.2 | 26.2 | 26.2 | 26.2 |
| | Filler shape | spherical | spherical | spherical | spherical | spherical | spiking | spiking | spherical |
| | Aspect ratio | 1.1 | 1.1 | 1.1 | 1.1 | 1.1 | 1.2 | 1.2 | 1.1 |
| Load of electroconductive filler (part | | 35 | 15 | 45 | 35 | 35 | 35 | 35 | 35 |
| by weight per 100 parts by weight of | | | | | | | | | |
| solids contents of solution | | | | | | | | | |
| of acrylic resin composition | | | | | | | | | |
| Content of electroconductive filler | | 34.3 | 14.7 | 44.1 | 34.3 | 34.3 | 34.3 | 34.3 | 34.3 |
| (part by weight per 100 parts by | | | | | | | | | |
| weight of total solids contents of | | | | | | | | | |
| pressure-sensitive adhesive other | | | | | | | | | |
| than filler | | | | | | | | | |
| Thickness of pressure-sensitive | | 20 | 20 | 20 | 15 | 25 | 15 | 20 | 20 |
| adhesive layer (μm) | | | | | | | | | |
| Substrate | Type | Al foil | Al foil | Al foil | Al foil | Al foil | Al foil | Al foil | none |
| | Thickness (μm) | 40 | 40 | 40 | 40 | 40 | 40 | 40 | — |

Evaluations

| | | | | | | | | |
|---|---|---|---|---|---|---|---|---|
| Adhesive strength (N/20 mm) | 7.2 | 9.5 | 7.7 | 3.6 | 8.3 | 5.4 | 7.1 | 7.2 |
| Resistance (mΩ/cm²) | 21 | 21 | 20 | 18 | 21 | 24 | 16 | 21 |
| Appearance | Good | Good | Good | Good | Good | Good | Good | Good |
| Bump-absorptivity | Good | Good | Good | Good | Good | Good | Good | Good |

TABLE 2

| | | Com. Ex. 1 | Com. Ex. 2 | Com. Ex. 3 | Com. Ex. 4 | Com. Ex. 5 | Com. Ex. 6 |
|---|---|---|---|---|---|---|---|
| Electroconductive filler | Filler type | nickel | nickel | nickel | nickel | nickel | nickel |
| | Name | 4SP-400 | 4SP-400 | 4SP-400 | Ni287 | Ni287 | Ni-Flake 95 |
| | | | | | Ni123 | Ni123 | |
| | d₅₀ (μm) | 12.0 | 12.0 | 12.0 | 16.7 (*1) | 19.1 (*1) | 10.7 |
| | d₈₅ (μm) | 26.2 | 26.2 | 26.2 | 40.4 (*2) | 44.0 (*2) | 22.9 |
| | Filler shape | spherical | spherical | spherical | Ni287: | Ni287: | flaky |
| | | | | | filamentary | filamentary | |
| | | | | | Ni123: spiking | Ni123: spiking | |
| | Aspect ratio | 1.1 | 1.1 | 1.1 | Ni287: 5.5 | Ni287: 5.5 | 6.0 |
| | | | | | Ni123: 1.2 | Ni123: 1.2 | |
| Load of electroconductive filler | | 10 | 35 | 35 | Ni287: 17.5 | Ni287: 24.5 | 35 |
| (part by weight per 100 parts by | | | | | Ni123: 17.5 | Ni123: 10.5 | |
| weight of solids contents of | | | | | | | |
| solution of acrylic resin composition | | | | | | | |
| Content of electroconductive filler | | 9.8 | 34.3 | 34.3 | 17.2 (*3) | 10.3 (*3) | 34.3 |
| (part by weight per 100 parts by | | | | | | | |
| weight of total solids contents of pressure- | | | | | | | |
| sensitive adhesive other than filler | | | | | | | |
| Thickness of pressure-sensitive adhesive | | 20 | 10 | 30 | 33 | 33 | 20 |
| layer (μm) | | | | | | | |
| Substrate | Type | Al foil | Al foil | Al foil | Al foil | Al foil | Al foil |
| | Thickness (μm) | 40 | 40 | 40 | 40 | 40 | 40 |

Evaluations

| | | | | | | |
|---|---|---|---|---|---|---|
| Adhesive strength (N/20 mm) | 10.4 | 1.0 or less | 9.8 | 10.2 | 9.2 | 8.0 |
| Resistance (mΩ/cm²) | 66 | — | 620 | 118 | 133 | 1050 |
| Appearance | Good | Remarkable | Good | Good | Good | Good |
| | | unevenness | | | | |
| Bump-absorptivity | Good | Poor | Good | Good | Good | Good |

4SP-400: “4SP-400” supplied by Novamet Specialty Products Corporation
Ni287: “Ni287” supplied by Vale Inco Limited
Ni123: “Ni123” supplied by Vale Inco Limited
Ni-Flake 95: “Ni-Flake 95” supplied by Fukuda Metal Foil and Powder Co., Ltd.
(*1): the value as a mixture of two types of particles; for respective particles, Ni287: 21.5 μm and Ni123: 11.2 μm
(*2): the value as a mixture of two types of particles; for respective particles, Ni287: 48.0 μm and Ni123: 26.2 μm
(*3): the content of Ni123 alone

As demonstrated by the evaluation results in Tables 1 and 2, the electroconductive pressure-sensitive adhesive tapes according to the present invention (Examples 1 to 8) have both superior adhesive strengths and high electroconductivity (low resistances) and have good appearances. In addition, the electroconductive pressure-sensitive adhesive tapes according to the present invention (Examples 1 to 8) show superior bump-absorptivity even when applied to bumped portions in the testing according to the evaluation method (7).

In contrast, the sample having a small content of a spherical or spiking electroconductive filler (Comparative Example 1) and the samples having a thickness of the pressure-sensitive adhesive layer of equal to or more than the filler diameter d₈₅ (Comparative Examples 3 to 6) show inferior electroconductivity; and the sample having a thickness of the pressure-sensitive adhesive layer of equal to or less than the filler diameter d₅₀ (Comparative Example 2) shows remarkable unevenness of its surface and shows an inferior adhesive strength.

### INDUSTRIAL APPLICABILITY

The electroconductive pressure-sensitive adhesive tapes according to embodiments of the present invention, though being thin, have both satisfactory adhesive strengths (bond strengths) and high electroconductivity and, in addition, have such superior bump-absorptivity as not to suffer from “lifting” from adherends even when applied to bumped portions of adherends. Accordingly, these electroconductive pressure-sensitive adhesive tapes, when adopted to the production typically of electrical/electronic appliances, help to improve the productivity and quality of the products. More specifically, the electroconductive pressure-sensitive adhesive tapes are useful typically for electromagnetic shielding typically from electrical/electronic appliances and cables and for establishing a ground for static protection typically of electrical components and optical films.

1. An electroconductive pressure-sensitive adhesive tape comprising a pressure-sensitive adhesive layer including a pressure-sensitive adhesive and having a thickness of from 10 to 30 μm, the pressure-sensitive adhesive containing at least one electroconductive filler in a content of from 14 to 45 parts by weight per 100 parts by weight of the total solids contents of the pressure-sensitive adhesive other than fillers, the electroconductive filler being spherical and/or spiking, having an aspect ratio of 1.0 to 1.5, and occupying 90 percent by weight or more of the total weight of fillers contained in the pressure-sensitive adhesive, wherein the electroconductive filler has such particle diameters d₅₀ and d₈₅, and the pressure-sensitive adhesive layer has such a thickness as to satisfy the following condition: d₈₅>(the thickness of the pressure-sensitive adhesive layer)>d₅₀.

2. The electroconductive pressure-sensitive adhesive tape according to claim 1, wherein the pressure-sensitive adhesive is an acrylic pressure-sensitive adhesive.

3. The electroconductive pressure-sensitive adhesive tape according to claim 1, wherein the pressure-sensitive adhesive, after crosslinked to have a crosslinked structure, has a storage elastic modulus G′ of 1×10⁴ Pa or more and less than 1×10⁶ Pa at temperatures ranging from 0° C. to 40° C. as determined in a dynamic viscoelastic test and has a peak temperature of loss tangent tan δ of 0° C. or lower.

4. The electroconductive pressure-sensitive adhesive tape according claim 1, wherein the electroconductive filler is at least one selected from the group consisting of metal fillers and metal-coated fillers.

5. The electroconductive pressure-sensitive adhesive tape according claim 1, comprising a substrate including a metallic foil; and the pressure-sensitive adhesive layer present on or above at least one surface of the substrate.

6. The electroconductive pressure-sensitive adhesive tape according to claim 5, wherein the pressure-sensitive adhesive layer is present on or above both surfaces of the substrate.

7. The electroconductive pressure-sensitive adhesive tape according to claim 2, wherein the pressure-sensitive adhesive, after crosslinked to have a crosslinked structure, has a storage elastic modulus G′ of 1×10⁴ Pa or more and less than 1×10⁶ Pa at temperatures ranging from 0° C. to 40° C. as determined in a dynamic viscoelastic test and has a peak temperature of loss tangent tan δ of 0° C. or lower.

8. The electroconductive pressure-sensitive adhesive tape according to claim 2, wherein the electroconductive filler is at least one selected from the group consisting of metal fillers and metal-coated fillers.

9. The electroconductive pressure-sensitive adhesive tape according to claim 3, wherein the electroconductive filler is at least one selected from the group consisting of metal fillers and metal-coated fillers.

10. The electroconductive pressure-sensitive adhesive tape according to claim 7, wherein the electroconductive filler is at least one selected from the group consisting of metal fillers and metal-coated fillers.

11. The electroconductive pressure-sensitive adhesive tape according to claim 2, comprising a substrate including a metallic foil; and the pressure-sensitive adhesive layer present on or above at least one surface of the substrate.

12. The electroconductive pressure-sensitive adhesive tape according to claim 3, comprising a substrate including a metallic foil; and the pressure-sensitive adhesive layer present on or above at least one surface of the substrate.

13. The electroconductive pressure-sensitive adhesive tape according to claim 4, comprising a substrate including a metallic foil; and the pressure-sensitive adhesive layer present on or above at least one surface of the substrate.

14. The electroconductive pressure-sensitive adhesive tape according to claim 7, comprising a substrate including a metallic foil; and the pressure-sensitive adhesive layer present on or above at least one surface of the substrate.

15. The electroconductive pressure-sensitive adhesive tape according to claim 8, comprising a substrate including a metallic foil; and the pressure-sensitive adhesive layer present on or above at least one surface of the substrate.

16. The electroconductive pressure-sensitive adhesive tape according to claim 9, comprising a substrate including a metallic foil; and the pressure-sensitive adhesive layer present on or above at least one surface of the substrate.

17. The electroconductive pressure-sensitive adhesive tape according to claim 10, comprising a substrate including a metallic foil; and the pressure-sensitive adhesive layer present on or above at least one surface of the substrate.

18. The electroconductive pressure-sensitive adhesive tape according to claim 11, wherein the pressure-sensitive adhesive layer is present on or above both surfaces of the substrate.

19. The electroconductive pressure-sensitive adhesive tape according to claim 12, wherein the pressure-sensitive adhesive layer is present on or above both surfaces of the substrate.

20. The electroconductive pressure-sensitive adhesive tape according to claim 13, wherein the pressure-sensitive adhesive layer is present on or above both surfaces of the substrate.
